(19) United States
(12) Patent Application Publication
(10) Pub. No.: US 2023/0109978 A1
(43) Pub. Date: Apr. 13, 2023

(54) VIRTUAL AUTOMATED MARKET MAKER (VAMM) SYSTEM AND METHOD FOR CREATING PREDICTION MARKETS

(71) Applicant: Vineet Kumar Dwivedi, Bangalore (IN)

(72) Inventor: Vineet Kumar Dwivedi, Bangalore (IN)

(21) Appl. No.: 17/496,789

(22) Filed: Oct. 8, 2021

(51) Int. Cl. G06Q 40/04

(52) U.S. Cl. CPC G06Q 40/04

(57) ABSTRACT

A virtual automated market maker system and method for creating prediction markets is disclosed. The method comprises receiving a request for creating a prediction market for a binary event from event creator. The method comprises receiving initial odds for the binary event from the event creator. Furthermore, the method comprises generating YES virtual coins and NO virtual coins based on total number of the desired virtual coins and the received initial odds. Also, the method comprises computing YES price value and NO price value based on the generated YES virtual coins, the NO virtual coins and the sum of the YES virtual coins and the NO virtual coins. Moreover, the method comprises determining whether there exists a transaction for the received binary event. Also, the method comprises adjusting the computed YES price value for the YES outcome and the NO price value of the NO outcome based on the transaction.

### FIELD OF INVENTION

Embodiments of the present disclosure relate to blockchain networks and more particularly relates to virtual automated market maker (VAMM) system and method for creating prediction markets in a blockchain network.

### BACKGROUND

Prediction markets trade probabilities of an event's outcome based on factual information gathered by all participants involved. Unlike dealing with preset odds, prices of the event's outcome are determined by all participants' activity in the prediction markets. The events are future events, and their examples may include outcome of elections, weather, sports events, and the success of new products and the like. The prediction markets make use of an automated market maker (AMM), which is a market participant. Such AMM is a bot which makes sure there are always some outcome tokens for every event's outcome in its inventory and that there is always a price that can be offered for the outcome tokens. As long as the AMM is active, the participants can buy and sell the outcome tokens for the prediction market, and the AMM aggregates trade data to produce estimates for odds of the outcomes. Typically, the prices of the outcome tokens on the prediction market reflects what the participants think the outcome will be. In these prediction markets, the participants buy and sell contingent securities in a marketplace. These securities represent the possible outcomes of a given forecasting question. The participants in the prediction market buy and sell these outcome tokens with the hope of owning the securities representing the correct outcome, which will have a value. By applying market forces and letting participants trade in the outcome tokens with real money or other valuable commodity, accurate forecasts are obtained.

Conventionally, there exists state of the art prediction markets implemented in blockchain technologies. Such existing blockchain technologies includes Hanson's Logarithmic Market Scoring Rule (LMSR) or Constant Product Market Makers (CPMM) or the like. These existing market makers have drawbacks and face multiple problems. One of the key problems with such existing blockchain technologies is that with lower amount of risk deposits, the curve becomes almost flat. Any event that has mutually exclusive outcomes (say Yes or No), the automated market maker (or Liquidity Provider or Guarantor) has to provide money that acts as guarantee for “worst case” scenarios. (For example, all the participants buying YES positions, and the eventual outcome also happens to be Yes). This can be loosely termed as minimum deposit, or maximum loss. This is higher in cases of such existing blockchain technologies. Another key problem is that the existing blockchain technologies rely on other crypto tokens to represent the outcomes, for example, Gnosis need minting of special cryptographic tokens (ERC-1155 tokens) to simulate conditions. For example, an ERC-1155 Yes Token and No Token. This makes it heavy computationally on a blockchain network.

Price discovery is a very important aspect of a market maker. In case of very high or low probabilities, and large orders, such existing algorithms (LMSR, CPMM) become almost flat at both ends, prohibiting an efficient price discovery. Furthermore, Hanson's LMSR works by setting liquidity parameter (called b), which caps maximum loss to be b*ln(2). The setting of odds in this is very cumbersome, and it does not allow liquidity to be added later, based on prevailing ratios.

Multiple logarithmic and exponential functions makes Hanson's LMSR computationally inefficient and unsuitable for large scale market maker because of an inherent computation cost (called gas fee) in blockchain networks.

Another problem with existing algorithms is that the maximum loss is guaranteed if the event progresses in either direction. The event creator has to charge a commission on each transaction in order to cover his risk capital and make profit. In many scenarios the event creator ends up losing money despite charging commission.

Hence, there is a need for an improved virtual automated market maker (VAMM) system and method for creating prediction markets in a blockchain network in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computer-implemented method for creating prediction markets using virtual automated market maker is disclosed. The computer-implemented method comprises receiving a request for creating a prediction market for a binary event from event creator. The method comprises receiving initial odds for the binary event from the event creator. The initial odds comprises a YES outcome and a NO outcome. One of the YES outcome and the NO outcome may correspond to higher probability of occurrence and the other of the YES outcome and the NO outcome correspond to lower probability of occurrence. Further, the method comprises receiving a request for creating a desired virtual coins for the binary event and for the received initial odds from the event creator. Furthermore, the method comprises generating YES virtual coins corresponding to the YES outcome and NO virtual coins corresponding to the NO outcome based on total number of the desired virtual coins and the received initial odds. Also, the method comprises computing YES price value for the YES outcome and NO price value for the NO outcome based on the generated YES virtual coins, the NO virtual coins and the sum of the YES virtual coins and the NO virtual coins. Additionally, the method comprises creating the prediction market for the binary event based on the received odds, the desired virtual coins. The initial YES price value and the NO price value is computed from received odds. Moreover, the method comprises determining whether there exists a transaction for the received binary event. The transaction comprises buying and selling of the generated YES virtual coins and the NO virtual coins. Also, the method comprises adjusting the computed YES price value for the YES outcome and the NO price value of the NO outcome based on the transaction. Upon each transaction, the sum of the YES price value and the NO price value is adjusted to be equal to number one constantly.

In accordance with another embodiment of the present disclosure, a virtual automated market maker (VAMM) system for creating prediction markets is disclosed. The VAMM system comprises one or more hardware processors and a memory coupled to the one or more hardware processors. The memory comprises a plurality of modules in the form of programmable instructions executable by the one or more hardware processors. The plurality of modules comprises a market setup module configured to receive a request for creating a prediction market for a binary event from event creator. The market setup module is further configured to receive initial odds for the binary event from the event creator, wherein the initial odds comprises a YES outcome and a NO outcome. One of the YES outcome and the NO outcome may correspond to higher probability of occurrence and the other of the YES outcome and the NO outcome correspond to least probability of occurrence. The market setup module is further configured to receive a request for creating a desired virtual coins for the binary event and for the received initial odds from the event creator. The plurality of modules further comprises a virtual coin generator module configured to generate YES virtual coins corresponding to the YES outcome and NO virtual coins corresponding to the NO outcome based on the desired virtual coins and the received initial odds. Further, the plurality of modules comprises a price computing module configured to compute YES price value for the YES outcome and NO price value for the NO outcome based on the generated YES virtual coins, the NO virtual coins and the sum of the YES virtual coins and the NO virtual coins. Furthermore, the plurality of modules comprises a market creator module configured to create the prediction market for the binary event based on the received odds, the desired virtual coins, the YES virtual coins, the NO virtual coins, the YES price value and the NO price value. Also, the plurality of modules comprises a transaction management module configured to determine whether there exists a transaction for the received binary event, wherein the transaction comprises buying and selling of the generated YES virtual coin and the NO virtual coins. Additionally, the plurality of modules comprises a price optimization module configured to adjust the computed YES price value for the YES outcome and the NO price value of the NO outcome based on the transaction, wherein upon each transaction, the sum of the YES price value and the NO price value is adjusted to be equal to a number one constantly.

The plurality of modules further comprises a risk capital value computation module configured to compute a risk capital value for the received initial odds based on the following risk capital value=Maximum of [number of NO virtual coins, number of YES virtual coins].

Embodiment of the present disclosure also provide a non-transitory computer-readable storage medium having instructions stored therein that, when executed by a hardware processor, cause the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary block chain network for creating prediction markets, in accordance with an embodiment of the present disclosure;

FIG. 2 is a block diagram illustrating an exemplary virtual automated market maker (VAMM) system, such as those shown in FIG. 1, capable of creating prediction markets, in accordance with an embodiment of the present disclosure;

FIG. 3 is a process flow diagram illustrating an exemplary method for creating prediction markets using virtual automated market maker, in accordance with an embodiment of the present disclosure;

FIG. 4 is a graphical representation depicting a comparison of variations in a cost of a coin in three different algorithms for the same risk capital or maximum loss, in accordance with an embodiment of the present disclosure;

FIG. 5 is a tabular representation depicting computation of price values of YES outcomes and NO outcomes, in accordance with another embodiment of the present disclosure;

FIG. 6 is a tabular representation depicting changes in buying cost and selling cost of YES and NO coins, in accordance with an embodiment of the present disclosure;

FIG. 7A-B are snapshot of an exemplary user interface depicting a dashboard of created prediction market with analysis reports, in accordance with an embodiment of the present disclosure; and

FIG. 8 is a snapshot of an exemplary user interface depicting a dashboard of various binary events created by multiple event creators, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Throughout the specification, the terms “subsystem” and “module” are used interchangeably.

A computer system (standalone, client or server computer system) configured by an application may constitute a “subsystem” that is configured and operated to perform certain operations. In one embodiment, the “subsystem” may be implemented mechanically or electronically, so a subsystem may comprise dedicated circuitry or logic that is permanently configured (within a special-purpose processor) to perform certain operations. In another embodiment, a “subsystem” may also comprise programmable logic or circuitry (as encompassed within a general-purpose processor or other programmable processor) that is temporarily configured by software to perform certain operations.

Accordingly, the term “subsystem” should be understood to encompass a tangible entity, be that an entity that is physically constructed permanently configured (hardwired) or temporarily configured (programmed) to operate in a certain manner and/or to perform certain operations described herein.

Embodiments of the present disclosure disclose a Virtual Automated Market Maker (VAMM) system for creating prediction markets. The VAMM system allows participants to take leveraged buy or sell positions for mutually exclusive outcomes of an event (e.g., a binary event resolving into either a YES or a NO) without a counterparty. The present invention does not require any other crypto tokens; however, the present invention simply works off collateral, that is deposited in native token of respective blockchain, e.g., ETH in case of Ethereum Blockchain. As an example, one of the known Automated Market Maker, requires existing crypto tokens to be added to pools, by Liquidity Providers. However, the VAMM system of the present invention works with numbers and math functions and tracks open/close positions for each outcome (e.g., Yes/No for Binary). Math Function of the present invention computes current price of each outcome, based on liquidity on each “side”. e.g., for a Binary outcome, having X and Y liquidity for Yes/No, the price is respectively Y/(X+Y) and X(X+Y).

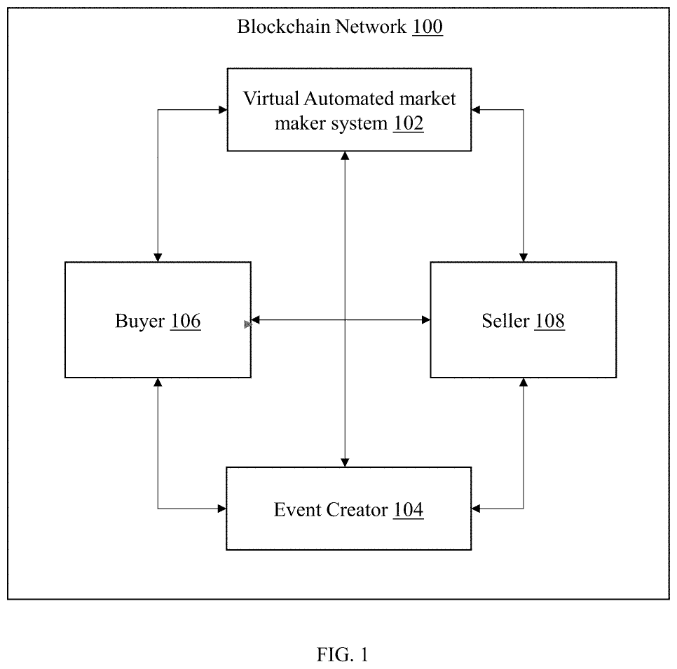

Referring now to the drawings, and more particularly to FIGS. 1 through 8, where similar reference characters denote corresponding features consistently throughout the figures, there are shown preferred embodiments and these embodiments are described in the context of the following exemplary system and/or method.

FIG. 1 is a block diagram illustrating an exemplary block chain network 100 for creating prediction markets in accordance with an embodiment of the present disclosure. According to FIG. 1, the blockchain network 100 comprises a virtual automated market maker (VAMM) system 102, an event creator 104, a buyer 106 and a seller 108. Each of the virtual automated market maker system 102, the event creator 104, the buyer 106 and the seller 108 corresponds to block chain nodes in the block chain network 100. The virtual automated market maker (VAMM) system 102 is connected to each of the event creator 104, the buyer 106 and the seller 108. Similarly, each of the block chain nodes are connected to every other block chain node in the blockchain network 100. The event creator 104 block node is configured for sending a request for creating a binary event and for providing with desired virtual coins for creating the binary event. The binary event may be any futuristic event and always have two outcomes. For example, the binary event may be any sports event, weather event, election event and the like. The two outcomes may be YES outcome (which means question under the binary event is going to happen) and a NO outcome (which means the question under the binary event is not going to happen). The event creator 104 also provides the initial odds for the creating the binary event. Further, the event creator 104 is also responsible for paying a risk capital value calculated by the VAMM system 102. The event creator 104 may be a subject matter expert, or an event follower or the like.

The VAMM system 102 is configured for creating prediction markets. Specifically, the VAMM system 102 is configured to receive a request for creating a prediction market for a binary event from event creator 104. For example, the event creator 104 may log into the VAMM system 102 for raising the request. The request may comprise of details of the binary event. The details may include title, question, domain, date of occurrence of the binary event, trade event end date, liquidity provider fee and the like. Further, the VAMM system 102 is configured to receive initial odds for the binary event from the event creator. The initial odds comprises a YES outcome and a NO outcome. One out of the YES outcome and the NO outcome corresponds to higher probability of occurrence and the other out of the YES outcome and the NO outcome correspond to least probability of occurrence. For example, for a given binary event, the chances of YES outcome may be higher than the chance of NO outcome.

Further, the VAMM system 102 is configured to receive a request for creating a desired virtual coins for the binary event and for the received initial odds from the event creator 104. The desired virtual coins may be the number of virtual coins which the event creator 104 is ready to invest for creating the prediction market. For example, for the binary event of a cricket match, the event creator 104 may request to create 10,000 virtual coins.

Further, the VAMM system 102 is configured to generate YES virtual coins corresponding to the YES outcome and NO virtual coins corresponding to the NO outcome based on total number of the desired virtual coins and the received initial odds. For example, in the same example as above, for 10,000 virtual coins, 7000 YES virtual coins and 3000 NO virtual coins may be generated. The distribution of YES and NO virtual coins depend on the probability of occurrence and the total number of desired virtual coins invested by the event creator 104.

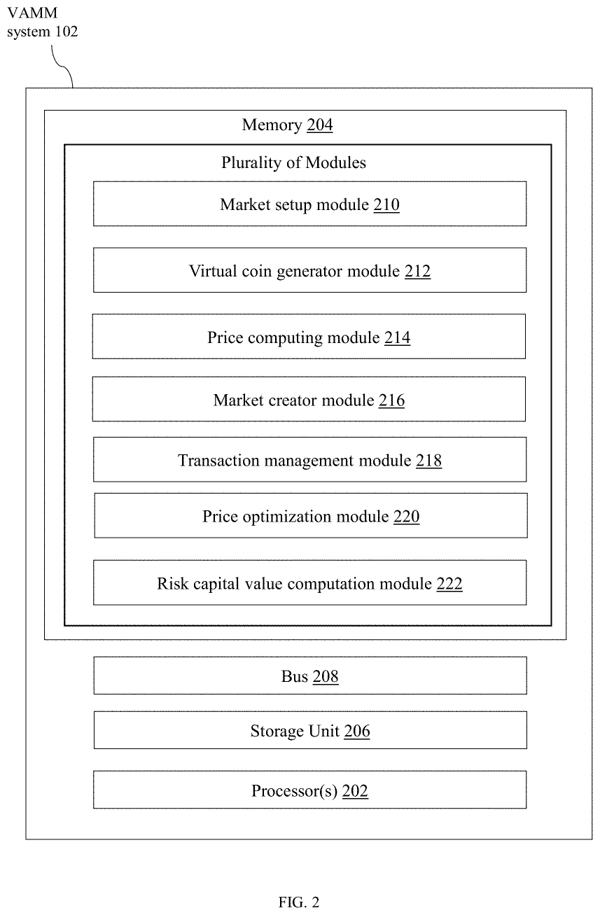

Further, the VAMM system 102 is configured to compute YES price value for the YES outcome and NO price value for the NO outcome based on the generated YES virtual coins, the NO virtual coins and the sum of the YES virtual coins and the NO virtual coins. The price of the YES virtual coins is referred as YES price value and the price of the NO virtual coins is referred as the NO price value. The details of the computation of YES price value and the NO price value is explained below with respect to FIG. 2.

Furthermore, the VAMM system 102 is configured to create the prediction market for the binary event based on the received odds, the desired virtual coins, the YES price value and the NO price value. Additionally, the VAMM system 102 is configured to determine whether there exists a transaction for the received binary event. The transaction comprises buying and selling of the generated YES virtual coins and the NO virtual coins. After creating the prediction market, the trading of the binary event starts. This allows all participants to perform the transaction, i.e., buying and selling of the generated YES virtual coins and the NO virtual coins. Any user or a participant may trade in the created binary event.

Moreover, the VAMM system 102 is configured to adjust the computed YES price value for the YES outcome and the NO price value of the NO outcome based on the transaction. Upon each transaction, the sum of the YES price value and the NO price value is adjusted to be equal to number one constantly. For example, if ‘x’ number of YES virtual coins are bought, then the YES price value is adjusted with respect to the remaining YES virtual coins and similarly the NO price value also gets adjusted for the same transaction with respect to the NO virtual coins. For example, if a participant has bought 1000 YES virtual coins out of 7000 YES virtual coins for YES price value say 0.3000, then after this transaction the YES price value is increased by a slippage value of 0.33333, which is calculated using a formula. The calculation is depicted in following description.

The VAMM system 102 is further configured to compute a risk capital value for the received initial odds based on the following:

Risk Capital Value=Maximum of [number of NO virtual coins,number of YES virtual coins]. equation (1)

The risk capital value is adjusted downwards if transaction fees is charged from the traders.

Such risk capital value amount is then received from the event creator 104 before creating the prediction market. The VAMM system 102 may be connected to one or more known payment gateways for receiving the payment from the event creator 104.

The buyer 106 is one of the participant to the prediction market created. The buyer 106 is also one of the blockchain node in the blockchain network 100. The buyer 106 purchases either one of the YES virtual coin or the NO virtual coins available at the time of trade by paying the YES price value or the NO price value respectively.

The seller 108 is another participant to the prediction market created. The seller 108 is also one of the blockchain node in the blockchain network 100. The seller 108 sells either one of the YES virtual coin or the NO virtual coins which he/she owns at the time of trade by quoting a sale value for the YES price value or the NO price value respectively.

Each of the buyer 106 and seller 108 may or may not be registered with the VAMM system 102. A non-registered buyer 106 and seller 108 may also participant in a trade.

Although, FIG. 1 illustrates the blockchain network 100 comprising the one or more blockchain nodes, one skilled in the art can envision that the blockchain network 100 can comprise further unlimited nodes interconnected with each other.

Those of ordinary skilled in the art will appreciate that the hardware depicted in FIG. 1 may vary for particular implementations. For example, other peripheral devices such as an optical disk drive and the like, Local Area Network (LAN), Wide Area Network (WAN), Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

Those skilled in the art will recognize that, for simplicity and clarity, the full structure and operation of all data processing systems suitable for use with the present disclosure is not being depicted or described herein. Instead, only so much of a blockchain network 100 as is unique to the present disclosure or necessary for an understanding of the present disclosure is depicted and described. The remainder of the construction and operation of the blockchain network 100 may conform to any of the various current implementation and practices known in the art.

FIG. 2 is a block diagram illustrating an exemplary virtual automated market maker (VAMM) system 102, such as those shown in FIG. 1, capable of creating prediction markets, in accordance with an embodiment of the present disclosure. The virtual automated market maker (VAMM) system 102 comprises a processor 202, a memory 204, and a database 206. The processor 202, the memory 204 and the database 206 are communicatively coupled through a system bus 208 or any similar mechanism. The memory 204 comprises a plurality of modules in the form of programmable instructions executable by the one or more processors 202. The plurality of modules further includes a market setup module 210, a virtual coin generator module 212, a price computing module 214, a market creator module 216, a transaction management module 218, a price optimization module 220 and a risk capital value computation module 222.

The processor(s) 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The processor(s) 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the processor(s) 202, such as being a computer-readable storage medium. The processor(s) 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes a plurality of modules stored in the form of machine-readable instructions on any of the above-mentioned storage media and may be in communication with and executed by the processor(s) 202.

The market setup module 210 is configured to receive a request for creating a prediction market for a binary event from event creator 104. Further, the market setup module 210 is configured to receive initial odds for the binary event from the event creator 104. The initial odds comprises a YES outcome and a NO outcome. One of the YES outcome and the NO outcome correspond to higher probability of occurrence and the other of the YES outcome and the NO outcome correspond to least probability of occurrence. Further, the market setup module 210 is configured to receive a request for creating a desired virtual coins for the binary event and for the received initial odds from the event creator 104.

The virtual coin generator module 212 is configured to generate YES virtual coins corresponding to the YES outcome and NO virtual coins corresponding to the NO outcome based on the desired virtual coins and the received initial odds.

The price computing module 214 is configured to compute YES price value for the YES outcome and NO price value for the NO outcome based on the generated YES virtual coins, the NO virtual coins and the sum of the YES virtual coins and the NO virtual coins. For example, for a binary event with Yes or No outcomes, if Yes side has X supply, and No side has Y supply, then price of Yes virtual coins is:

$$price of YES virtual coins = \frac{Y}{X + Y} \qquad equation ( 2 )$$

$$price of NO virtual coins = \frac{X}{X + Y} \qquad equation ( 3 )$$

If yes virtual coins is 700, No virtual coins is 300, then price of Yes virtual coins is 0.3 and price of No virtual coins is 0.7. The present VAMM system 102 therefore also allows very easy setup of initial Odds.

In an embodiment, number of virtual coins for each outcome depend on the received initial odds. If probability of the binary event occurring is determined to be p, then the YES price value corresponds to p, and the NO price value corresponds to (1-p), and the number of virtual coins generated is

Number of YES virtual coins=N*(1−p) equation (4)

Number of NO virtual coins=N*p equation (5)

In an embodiment,

$$Initial YES price value = \frac{NO virtual coins}{YES virtual coins + NO virtual coins} \qquad equation ( 6 )$$

$$Initial NO price value = \frac{YES virtual coins}{YES virtual coins + NO virtual coins} \qquad equation ( 7 )$$

The market creator module 216 is configured to create the prediction market for the binary event based on the received odds, the desired virtual coins, the YES virtual coins, the NO virtual coins, the YES price value and the NO price value. Once the prediction market is created, the prediction market is open for trading for all the participants.

The transaction management module 218 is configured to determine whether there exists a transaction for the received binary event. The transaction comprises buying and selling of the generated YES virtual coin and the NO virtual coins.

The price optimization module 220 is configured to adjust the computed YES price value for the YES outcome and the NO price value of the NO outcome based on the transaction. Upon completion of each transaction, the sum of the YES price value and the NO price value is adjusted to be equal to a number one constantly. In adjusting the computed YES price value for the YES outcome and the NO price value of the NO outcome based on the transaction, the price optimization module 220 is further configured to determine whether the transaction is made for the YES outcome and whether no transaction is made for the NO outcome. This means that the participants have only bought or sold YES virtual coins and there is no transaction made for NO virtual coins. In such a case, the price optimization module 220 is configured to determine whether result of the binary event upon occurrence is equivalent to the YES outcome. Furthermore, the price optimization module 220 is configured to adjust the computed YES price value for the YES outcome to be equivalent to the number one and the NO price value for the NO outcome to be equivalent to zero.

In an alternate embodiment, in adjusting the computed YES price value for the YES outcome and the NO price value of the NO outcome based on the transaction, the price optimization module 220 is further configured to determine whether the transaction comprises buying of the YES outcome. In such case, the price optimization module 220 is further configured to increase the YES price value for the YES outcome if the transaction comprises buying of the YES outcome. Also, the price optimization module 220 is further configured to automatically decrease the NO price value for the NO outcome if the transaction comprises buying of the YES outcome. The sum of the increased YES price value and the decreased NO price value is equivalent to the defined number constantly, which is one.

In this case, instantaneous or Spot price of YES virtual coins is:

$$Spot price of Yes virtual Coins = \frac{n}{n + y} \qquad equation ( 8 )$$

If currency m is deposited to buy Δy coins, the VAMM system 102 prints m number of YES coins and m number of NO coins. The ‘m’ is computed in such a way that unit price is same as final instantaneous or spot price:

$$m = Δ y * \frac{n + m}{n + y + 2 m - Δ y} \qquad equation ( 9 )$$

where n is the number of NO virtual coins and y is the number of YES virtual coins with the VAMM system 102 and Δy is the YES virtual coins purchased by the trader, such as buyer 106 or seller 108 for currency m. After the purchase, the VAMM system 102 has (n+m) number of NO coins and (y+m-Δy) number of YES coins.

The spot NO price value before purchase is:

$$Spot NO price value = \frac{y}{n + y} \qquad equation ( 10 )$$

After purchase of Δy YES virtual coins, a new spot YES price value is given by:

$$New spot YES price value = \frac{n + m}{n + y + 2 m - Δ y} ; \qquad equation ( 11 )$$

and new spot NO price value is given by:

$$New spot NO price value = \frac{( y + m - Δ y )}{n + y + 2 m - Δ y} \qquad equation ( 12 )$$

where m is the amount of currency given for purchasing.

Instant price for buying infinitesimal amount of YES will be NO/(YES+NO). As people buy more YES coins, the price of YES coins keeps getting closer to 1.

In an alternate scenario, in adjusting the computed YES price value for the YES outcome and the NO price value of the NO outcome based on the transaction, the price optimization module 220 is further configured to determine whether the transaction comprises buying of the NO outcome. In such a case, the price optimization module 220 is further configured to increase the NO price value for the NO outcome if the transaction comprises buying of the NO outcome. Also, the price optimization module 220 is further configured to automatically decrease the YES price value for the YES outcome if the transaction comprises buying of the NO outcome. The sum of the increased NO price value and the decreased YES price value is equivalent to the number one constantly.

In this case, when a trader buys NO virtual coins and if currency m is deposited to buy Δn coins, the VAMM system 102 prints m number of YES coins and m number of NO coins. The ‘m’ is computed in such a way that unit price is same as final instantaneous or spot price:

m=Δn·(y+m)/(n+y+2m−Δn) equation (13)

where n is the number of NO virtual coins and y is the number of YES virtual coins with system before the transaction. In this case, spot YES price value of YES virtual coins before purchase is as given in equation (8) and spot NO price value before purchase is as given in equation (10). After purchase, the VAMM system 102 has (n+m−Δn) number of NO coins and (y+m) number of YES coins. Also, after purchase of the Δn NO virtual coins, new spot YES price value is:

$$New spot YES price value = \frac{n + m - Δ n}{n + y + 2 m - Δ n} ; \qquad equation ( 14 )$$

and new spot NO price value is given by:

$$New spot NO price value = \frac{y + m}{n + y + 2 m - Δ n} \qquad equation ( 15 )$$

Where m is the amount of money given for purchase. In yet another alternate scenario, in adjusting the computed YES price value for the YES outcome and the NO price value of the NO outcome based on the transaction, the price optimization module 220 is further configured to determine whether the transaction comprises selling of YES virtual coins. In such a case, amount received by a trader upon selling Δy YES virtual coins is:

$$Sale cost of Δ y YES virtual coins = Δ y * \frac{( n - m )}{n + y - 2 m + Δ y} \qquad equation ( 16 )$$

where n is the number of NO virtual coins and y is the number of YES virtual coins with the system and m is amount of money received in lieu of selling Δy YES coins. In such a case, spot YES price value before selling is as given in equation (8) and spot NO price value before selling is as given in equation (10). Further, after sale of the Δy YES virtual coins, the new spot YES price value is:

$$New spot YES price value = \frac{n - m}{n + y - 2 m + Δ y} ; \qquad equation ( 17 )$$

and new spot NO price value is given by:

$$New spot NO price value = \frac{( y - m + Δ y )}{n + y - 2 m + Δ y} \qquad equation ( 18 )$$

In still another alternate scenario, in adjusting the computed YES price value for the YES outcome and the NO price value of the NO outcome based on the transaction, the price optimization module 220 is further configured to determine whether the transaction comprises selling of NO virtual coins, wherein amount received by a trader, upon selling Δn NO virtual coins is:

$$Sale cost of Δ n NO virtual coins = Δ n * ( \frac{( y - m )}{n + y - 2 m + Δ n} ) \qquad equation ( 19 )$$

where n is the number of NO virtual coins and y is the number of YES virtual coins with the VAMM system 102 and m is money received in lieu of Δn NO coins. In such a case, spot YES price value before selling is as given in equation (8) and spot NO price value before selling is as given in equation (10). Further, after sale of Δn NO virtual coins, the new spot YES price value is:

$$New spot YES price value = \frac{n - m + Δ n}{n + y - 2 m + Δ n} ; \qquad equation ( 20 )$$

and new spot NO price value is given by:

$$New spot NO price value = \frac{y - m}{n + y - 2 m + Δ n} \qquad equation ( 21 )$$

In an additional embodiment, there is an option to create additional liquidity in the pool by adding the coins in the current ratio and paying risk capital value. When the event is closed, one of the coins becomes 1 and the other becomes 0 in value.

The risk capital value computation module 222 is configured to compute a risk capital value for the received initial odds based on the following:

Risk Capital Value=Maximum of [number of NO virtual coins,number of YES virtual coins] equation (22)

The risk capital value risk capital value is adjusted downwards if transaction fees is charged from the traders.

The risk capital value computation module 222 is further configured to output the computed risk capital value for the received initial odds on a user interface of a user device; and obtain a payment of the computed risk capital value for the received initial odds from the event creator 104.

In an exemplary embodiment, if the probability of an event occurring(YES) is 0.3, the event creator 104 or liquidity provider can create YES and NO virtual coins in the ratio of 0.7:0.3. The risk capital value is computed based on the number of virtual coins is computed using equation (1) and equation (22). For example, if someone wants to create 1000 virtual coins in the ratio of 300:700, the risk capital value is max of (300, 700)=$700.

In an exemplary embodiment, an incentive is generated and paid for the traders to place a series of small order of transactions rather than a huge order as unit price for buying and selling is spot price after the transaction. To counter this, a small price δ is added for each transaction making it inefficient for traders to make multiple small orders. This mechanism is cheaper to buy coin incrementally however for trades related to volatile and real-time events traders would prefer to purchase in bulk. The slippage in buying in bulk automatically creates more liquidity in the VAMM system 102.

In an exemplary embodiment, when a user is making a transaction, for example, buying of X coins, the VAMM system 102 calculates the price value for purchasing such X coins and receives payment from the user. In a given case, if X coins are purchased, it is noted that eventually price of such X coin increases after the purchase. In a standard mechanism, the user while purchasing the X coin is only given option to pay current price value of X coins, but not the increased price value of X coin after purchasing of such X coins. For example, say user is buying 100 YES coins, in this case current price of 1 YES coin is say 0.7. After purchase, the price of 1 YES coin raises to say 0.73333. Now, the VAMM system 102 receives 0.7333*100=73.33 currency as purchase cost from the user, instead of 0.7*100=70.00. This way a user pays an amount which actually impacts the system 102 after the transaction. This mechanism helps reduce the risk capital amount significantly and increases the liquidity in the system 102. This additional liquidity gained due to the price difference after purchase, helps is creating proportionate number of YES and NO coins additionally.

The storage unit 206 is configured to store the computed risk capital value, desired virtual coins, initial odds, binary event, YES virtual coins, NO virtual coins, YES price value, NO price value, adjusted price values, buying cost, sale cost and the like.

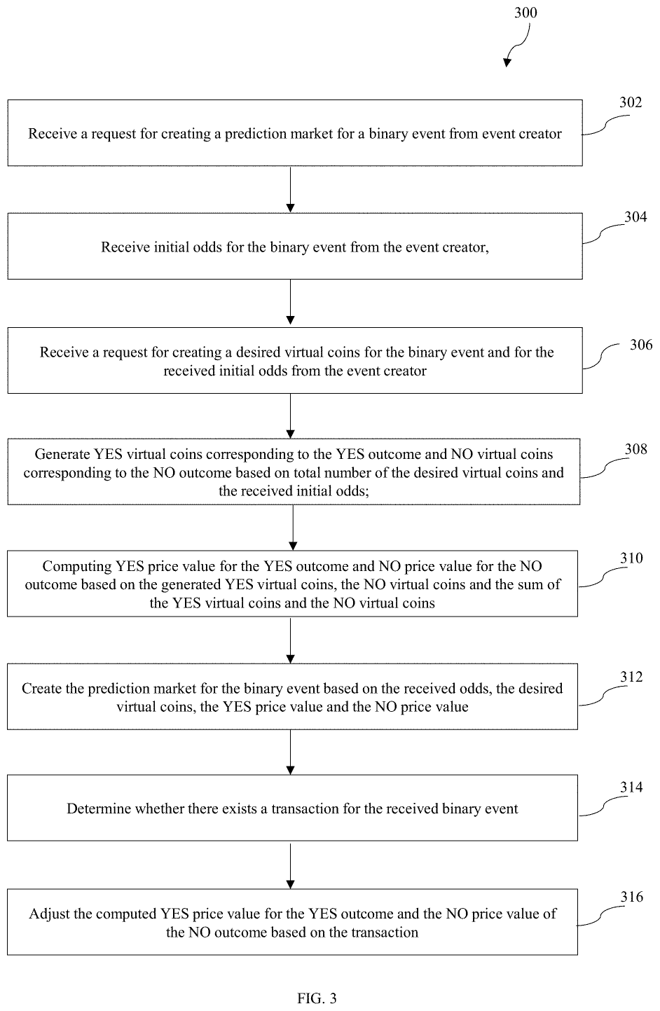

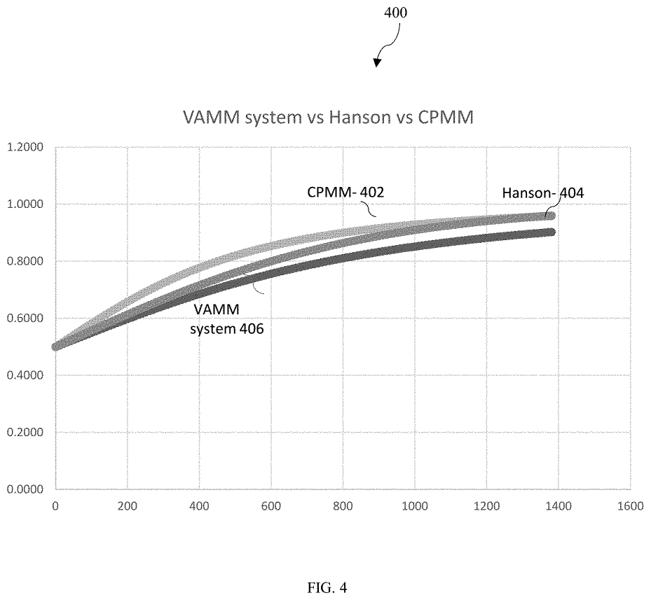

FIG. 3 is a process flow diagram illustrating an exemplary method 300 for creating prediction markets using virtual automated market maker system 102, in accordance with an embodiment of the present disclosure. At step 302, a request for creating a prediction market for a binary event is received from event creator 102. At step 304, initial odds for the binary event is received from the event creator 104. The initial odds comprises a YES outcome and a NO outcome. One of the YES outcome and the NO outcome correspond to higher probability of occurrence and the other of the YES outcome and the NO outcome correspond to least probability of occurrence. At step 306, a request for creating a desired virtual coins for the binary event and for the received initial odds is received from the event creator 104. At step 308, YES virtual coins corresponding to the YES outcome and NO virtual coins corresponding to the NO outcome are generated based on total number of the desired virtual coins and the received initial odds. At step 310, YES price value for the YES outcome and NO price value for the NO outcome is computed based on the generated YES virtual coins, the NO virtual coins and the sum of the YES virtual coins and the NO virtual coins. At step 312, the prediction market for the binary event is created based on the received odds, the desired virtual coins, the YES price value and the NO price value. At step 314, it is determined whether there exists a transaction for the received binary event. The transaction comprises buying and selling of the generated YES virtual coins and the NO virtual coins. At step 316, the computed YES price value for the YES outcome and the NO price value of the NO outcome is adjusted based on the transaction. Upon completion of each transaction, the sum of the YES price value and the NO price value is adjusted to be equal to number one constantly.

The method 300 further comprises computing a risk capital value for the received initial odds based on the equation (1) and equation (22).

The method 300 further comprises outputting the computed risk capital value for the received initial odds on a user interface of a user device. In this case, the user device may be one of the blockchain node. Further, the method 300 comprises obtaining a payment of the computed risk capital value for the received initial odds from the event creator 104. wherein number of virtual coins for each outcome depend on the received initial odds, wherein if probability of the binary event occurring is determined to be p, then the YES price value corresponds to p, and the NO price value corresponds to (1-p). The number of virtual coins generated is given by equation (4) and equation (5).

In adjusting the computed YES price value for the YES outcome and the NO price value of the NO outcome based on the transaction, the method 300 comprises determining whether the transaction is made for the YES outcome and whether no transaction is made for the NO outcome. Further, the method 300 comprises determining whether result of the binary event upon occurrence is equivalent to the YES outcome. Also, the method 300 comprises adjusting the computed YES price value for the YES outcome to be equivalent to the number one and the NO price value for the NO outcome to be equivalent to zero.

In an embodiment, in adjusting the computed YES price value for the YES outcome and the NO price value of the NO outcome based on the transaction, the method 300 comprises determining whether the transaction comprises buying of the YES outcome. Further, the method 300 comprises increasing the YES price value for the YES outcome if the transaction comprises buying of the YES outcome. Also, the method 300 comprises automatically decreasing the NO price value for the NO outcome if the transaction comprises buying of the YES outcome. The sum of the increased YES price value and the decreased NO price value is equivalent to the number one constantly. A spot YES price value before purchase is given by equation (8) and spot NO price value before purchase is given by equation (10). After purchase of Δy YES virtual coins, new spot YES price value is given by equation (11) and new spot NO price value is given by equation (12).

In another embodiment, in adjusting the computed YES price value for the YES outcome and the NO price value of the NO outcome based on the transaction, the method 300 comprises determining whether the transaction comprises buying of the NO outcome. The method 300 further comprises increasing the NO price value for the NO outcome if the transaction comprises buying of the NO outcome. Also, the method 300 comprises automatically decreasing the YES price value for the YES outcome if the transaction comprises buying of the NO outcome. The sum of the increased NO price value and the decreased YES price value is equivalent to the number one constantly. A buying cost of Δn NO virtual coins is given by equation (13). A spot YES price value of YES virtual coins before purchase is given by equation (8) and spot NO price value of NO virtual coins before purchase is given by equation (10). After purchase the Δn NO virtual coins, new spot YES price value is given by equation (14) and new spot NO price value is given by equation (15).

In yet another embodiment, in adjusting the computed YES price value for the YES outcome and the NO price value of the NO outcome based on the transaction, the method 300 comprises determining whether the transaction comprises selling of YES virtual coins. The amount received by a trader, upon selling Δy YES virtual coins is given by equation (16). A spot YES price value before selling is given by equation (8) and spot NO price value before selling is given by equation (10). After sale of the Δy YES virtual coins, new spot YES price value is given by equation (17) and new NO price value is given by equation (18).

In still another embodiment, in adjusting the computed YES price value for the YES outcome and the NO price value of the NO outcome based on the transaction, the method 300 comprises determining whether the transaction comprises selling of NO virtual coins, wherein amount received by a trader, upon selling Δn NO virtual coins is given by equation (19). A spot YES price value before selling is given by equation (8) and spot NO price value before selling is given by equation (10). After sale of Δn NO virtual coins, new spot YES price value is given by equation (20) and new spot NO price value is given by equation (21).

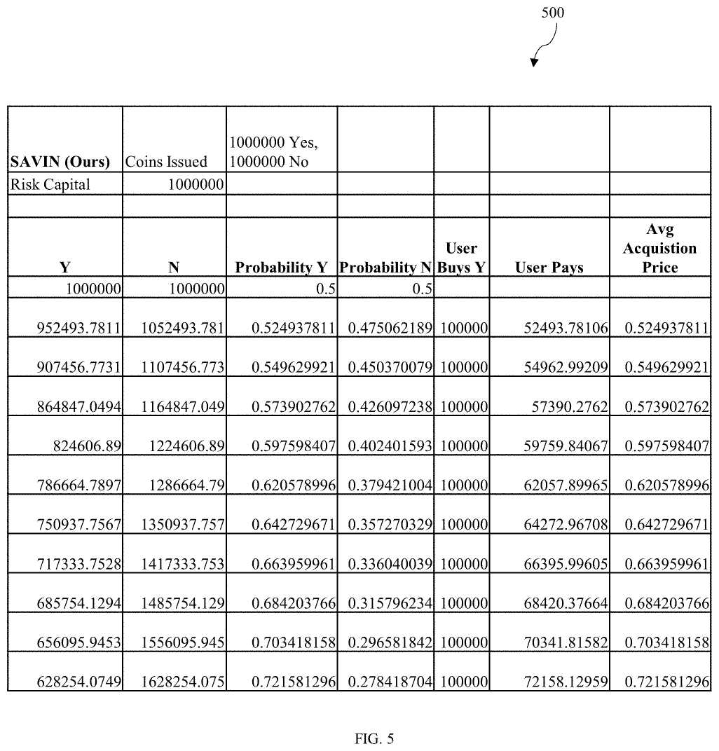

FIG. 4 is a graphical representation 400 depicting a comparison of variations in a cost of a virtual coin in three different blockchain methods, in accordance with an embodiment of the present disclosure. For example, FIG. 4 represents a comparison of how cost of a virtual coin moves when initial pool is 500:500. It can be observed that, when the probability of an outcome is low, one of the existing blockchain technology such as CPMM flats out and other existing blockchain technology such as Hanson fails to reach the value of 1. However, the present invention strikes the right balance, which is evident if looked at the graphs at low/high probabilities.

FIG. 5 is a tabular representation depicting computation of price values of YES outcomes and NO outcomes, in accordance with another embodiment of the present disclosure. According to FIG. 5, the event creator 104 provides initial odds for the binary event. For example, the initial odds received may be 0.5 for YES outcome and 0.5 for NO outcome. This means that the probability of occurrence of any one outcome is 50%. Further, the event creator 104 provides desired virtual coins for a binary event such as 2000000. With the desired virtual coins, risk capital value is computed using the formula given above. In this case, the risk capital value corresponds to 1000000. With this desired virtual coins, YES virtual coins and NO virtual coins are generated, such as 1000000 YES virtual coins and 1000000 NO virtual coins. With this, price for the YES virtual coin and the price for the NO virtual coin is computed as described above. For example, the initial price of YES virtual coin is 0.5 and the initial price of NO virtual coin is 0.5. With this data, now the prediction market is created. Whenever a transaction happens, for example if a user buys 100000 YES virtual coins, in such a case, the price of the YES virtual coins is adjusted to 0.5249378105604451 and the price of the NO virtual coins is adjusted to 0.4750622. In such a case, the user pays 52493.78105604451 as the buying cost. The buying cost of YES virtual coins is computed using the formula above. The system will generate 52493.78 YES virtual coins and 52493.78 NO virtual coins. Further, in this case, the number of available YES virtual coins now reduces to 1000000−100000+52492.78=952492.8 from 1000000 virtual coins. The number of available NO virtual coins will increase to 1052492.78. Moreover, the sum of the adjusted new prices of YES virtual coins and the NO virtual coins always remain equal to 1 (1=0.5249378+0.4750622). After each transaction, as the user keeps buying YES virtual coins, the price of the YES virtual coins keep increasing, the price of the NO virtual coins keep decreasing, the number of available YES virtual coins keep decreasing, number of NO virtual coins remain the same and the buying cost of the YES virtual coins keep increasing. At the end of the trade, the price value of the YES virtual coins keep growing closer to value 1, and the price value of the NO virtual coins keep decreasing closer to zero. At any point of the transaction, the sum of the price value of the YES virtual coins and the NO virtual coins shall always be equal to 1. Further, the average acquisition price keeps increasing after each transaction. The average acquisition price is given by buying cost/number of available NO virtual coins and vice versa in case of transaction with respect to buying of NO virtual coins. This is clearly shown in FIG. 5. Similar computation applies to a transaction where NO virtual coins are bought by the user. In such case, the price value of the NO virtual coins keeps increasing and growing closer to 1, whereas the price value of the YES virtual coins keeps decreasing and growing closer to zero.

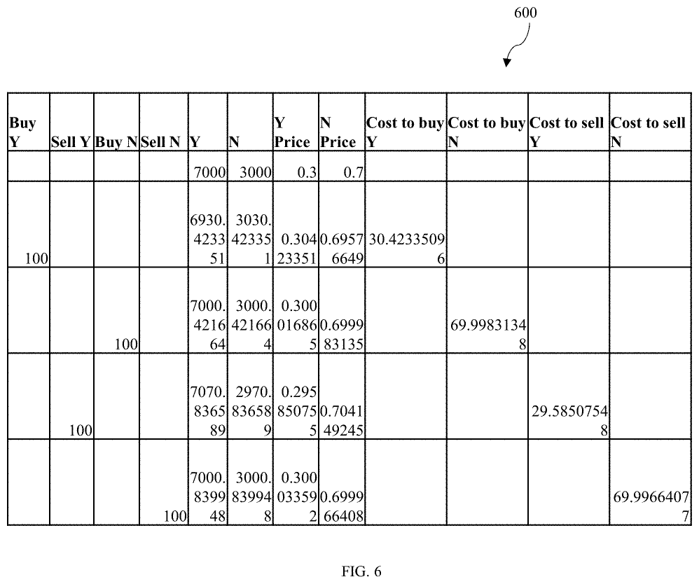

FIG. 6 is a tabular representation 600 depicting changes in buying cost and selling cost of YES and NO coins, in accordance with an embodiment of the present disclosure. In an exemplary embodiment, consider that there are 7000 YES virtual coins and 3000 NO virtual coins. The initial price of the YES virtual coin is 0.3 and the initial price of the NO virtual coin is 0.7. In this case, if a user buys 100 YES virtual coins, the cost computed will be 30.42. The system will generate 30.42 YES coins and 30.42 NO coins and give 100 YES coins to the user. The number of available YES virtual coins reduces to 6930.42 and the number of available NO virtual coins will increase to 3030.42. Upon this transaction, which is buying of 100 YES virtual coins, the new spot price of the YES virtual coins increases to 0.3042 and the new spot price of the NO virtual coins decreases to 0.6958. Further, the cost to buy the YES virtual coins becomes 30.42. In an alternate case, when a user buys 100 NO virtual coins, the number of available NO virtual coins reduces to 2906.4166 and the number of available YES virtual coins increase to 7070.4166. Upon this transaction, which is buying of 100 NO virtual coins, the new spot price of the NO virtual coins increases to 0.704166 and the new spot price of the YES virtual coins decreases to 0.295834. Further, the cost to buy the NO virtual coins becomes 70.4166. In another scenario, if a user sells 100 YES virtual coins, the number of available YES virtual coins increases to 7070.4166 and the number of available NO virtual reduces to 2970.4166. Upon this transaction, which is selling of 100 YES virtual coins, the new spot price of the YES virtual coins decreases to 0.295834 and the new spot price of the NO virtual coins increases to 0.704166. Further, the cost to sell the YES virtual coins becomes 29.58. Similarly, if a user wishes to sell 100 NO virtual coins, then the number of available NO virtual coins increases to 3030.42335 and the number of available YES virtual coins decreases to 6930.42335. Upon this transaction, which is selling of 100 NO virtual coins, the new spot price of the NO virtual coins decreases to 0.6957665 and the new spot price of the YES virtual coins increases to 0.3042335. Further, the cost to sell the NO virtual coins becomes 69.57665. In this case of selling, the system burns 69.57665 YES coins and 69.57665 NO coins which reduces their total number from the system.

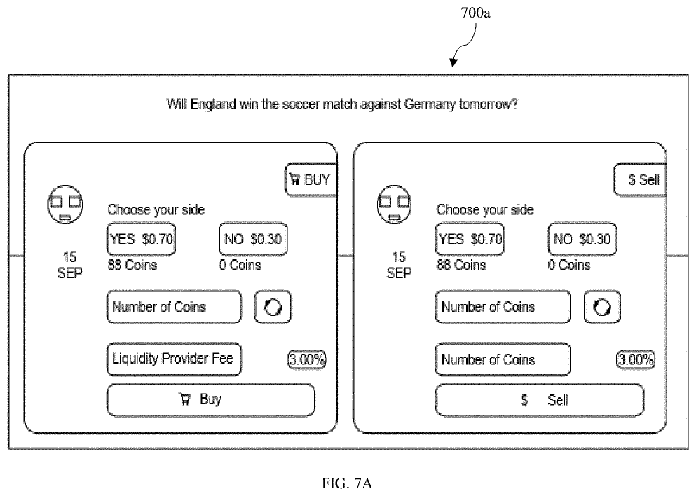

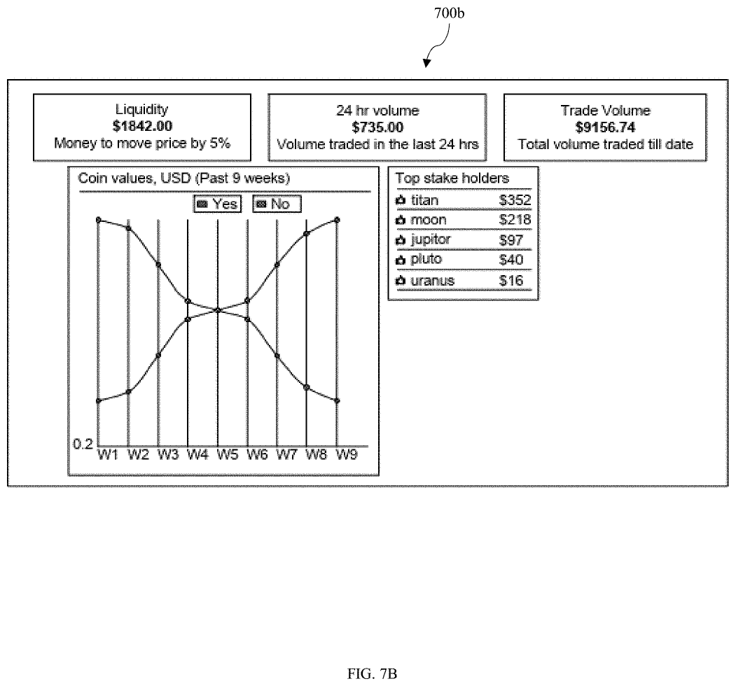

FIG. 7A-B are snapshot of an exemplary user interface depicting a dashboard of created prediction market with analysis reports, in accordance with an embodiment of the present disclosure. In FIG. 7A, a dashboard 700a of created binary event is depicted. Here, the binary event is titled as “Will England win the Soccer match against Germany tomorrow”. The dashboard 700a depicts two sections, one for buying the virtual coins and one for selling the virtual coins. The dashboard 700a also depicts the date of occurrence of the binary event. Further, the dashboard 700a also shows available virtual coins and their current price value. In FIG. 7B, a dashboard 700b of analytical reports for the binary event is depicted. Here, the dashboard 700b depicts the liquidity amount, volume traded in last 24 hours, trade volume, a graphical representation of current price of the virtual coins and top stakeholders.

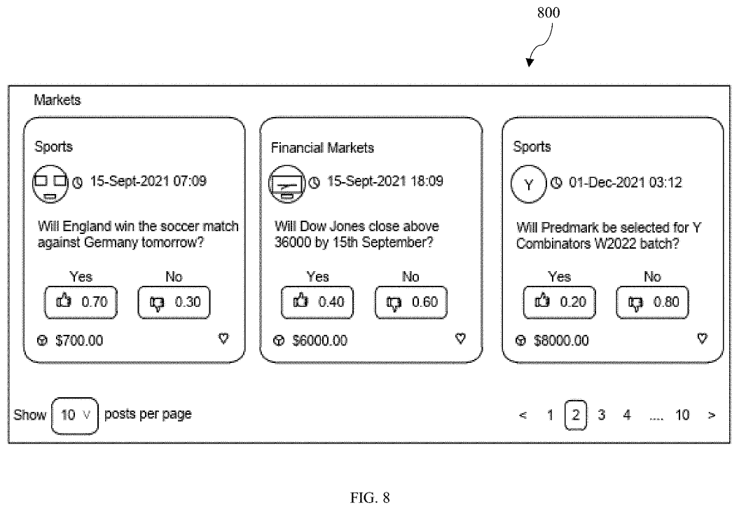

FIG. 8 is a snapshot of an exemplary user interface depicting a dashboard 800 of various binary events created by multiple event creators, in accordance with an embodiment of the present disclosure. The dashboard 800 depicts various created binary events for different domains such as sports, financial markets and the like. The dashboard 800 also depicts a quick overview of each such created binary events. The summary may include current price value of the YES and NO virtual coins, title of the binary event and date of occurrence of the binary event.

Various embodiments of the present system provide a technical solution to the problem of automating prediction markets by using superior and computationally efficient algorithm. The present system is specifically targeted at blockchains, since the present system is smart contracts based. The present invention has various advantages such as the present VAMM system 102 requires much less minimum deposit for same liquidity and price slippage conditions, compared to other conventional algorithms. The present system only tracks numbers in an array as compared to crypto tokens. Due to the use of arrays and positions, the present system may extend scheme to allow leveraged opening of positions. (e.g., by posting a collateral of 10 USD equivalent, a user can buy YES position worth 20 USD, if leverage is 2×). The present system closely reflects open positions on each outcome, and also price change is uniform and converges to 1 or 0 depending on outcome unlike known other blockchain technologies. The present system allows anyone to create a prediction market by setting an initial odd and depositing risk amount calculated by the algorithm.

The present system is more capital efficient, which can be proven mathematically, and also computationally light, especially on blockchain environments, where execution cost (called Gas Cost) can be prohibitively high.

The present VAMM system 102 has a simple intuitive formula that tracks the outcomes and converges to 1 or 0.

Further, a key criterion to determine price movement “smoothness” is slippage. A very high slippage means even small orders can make the prices “jump” a lot, and a very low slippage means even very big orders do not move the needle meaningfully. The present system strikes the right balance, which is evident if we look at the graphs at low/high probabilities.

Conventionally, in both Hanson's LMSR and CPMM are path independent. This means that if a user buys X number of YES coins and sell X number of NO coins, such conventional systems will come to same state. This means that such conventional system has exactly same number of YES or NO coins and cash (capital) as it was before the trans action.

In the present system, the VAMM system 102 keeps adding extra liquidity and the VAMM system 102 has marginally higher YES or NO coins and extra capital. The extra number of YES or NO coins matches the extra capital with the VAMM system 102. The amount of extra liquidity is proportional to size of purchase. This becomes really beneficial when there are large swings such as a game or volatile event. The extra liquidity can support high amount of transactions and therefore an event creator can earn more commission for his/her risk capital.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A computer-implemented method for creating prediction markets using virtual automated market maker, the method comprising:
receiving, by a processor, a request for creating a prediction market for a binary event from event creator;
receiving, by the processor, initial odds for the binary event from the event creator, wherein the initial odds comprises a YES outcome and a NO outcome, and wherein one of the YES outcome and the NO outcome correspond to higher probability of occurrence and the other of the YES outcome and the NO outcome correspond to least probability of occurrence;
receiving, by the processor, a request for creating a desired virtual coins for the binary event and for the received initial odds from the event creator;
generating, by the processor, YES virtual coins corresponding to the YES outcome and NO virtual coins corresponding to the NO outcome based on total number of the desired virtual coins and the received initial odds;
computing, by the processor, YES price value for the YES outcome and NO price value for the NO outcome based on the generated YES virtual coins, the NO virtual coins and the sum of the YES virtual coins and the NO virtual coins;
creating, by the processor, the prediction market for the binary event based on the received odds, the desired virtual coins, the YES price value and the NO price value;
determining, by the processor, whether there exists a transaction for the received binary event, wherein the transaction comprises buying and selling of the generated YES virtual coins and the NO virtual coins; and
adjusting, by the processor, the computed YES price value for the YES outcome and the NO price value of the NO outcome based on the transaction, wherein upon each transaction, the sum of the YES price value and the NO price value is adjusted to be equal to number one constantly.

2. The computer implemented method of claim 1, further comprising:
computing a risk capital value for the received initial odds based on the following: risk capital value=Maximum of [number of NO virtual coins, number of YES virtual coins], wherein
risk capital value is adjusted downwards if transaction fees is charged from the traders.

3. The computer implemented method of claim 2, further comprising:
outputting the computed risk capital value for the received initial odds on a user interface of a user device; and
obtaining a payment of the computed risk capital value for the received initial odds from the event creator.

4. The computer implemented method of claim 1, wherein number of virtual coins for each outcome depend on the received initial odds, wherein if probability of the binary event occurring is determined to be p, then the YES price value corresponds to p, and the NO price value corresponds to (1-p), and wherein the number of virtual coins generated is given by:
Number of YES virtual coins=N*(1-p); and
Number of NO virtual coins=N*p, where N is total number of coins desired.

5. The computer implemented method of claim 1, wherein initial YES price value=NO virtual coins/(YES virtual coins+NO virtual coins) and initial NO price value=YES virtual coins/(YES virtual coins+NO virtual coins).

6. The computer implemented method of claim 1, wherein adjusting the computed YES price value for the YES outcome and the NO price value of the NO outcome based on the transaction comprises:
determining whether the transaction is made for the YES outcome and whether no transaction is made for the NO outcome;
determining whether result of the binary event upon occurrence is equivalent to the YES outcome; and
adjusting the computed YES price value for the YES outcome to be equivalent to the number one and the NO price value for the NO outcome to be equivalent to zero.

7. The computer implemented method of claim 1, wherein adjusting the computed YES price value for the YES outcome and the NO price value of the NO outcome based on the transaction comprises:
determining whether the transaction comprises buying of the YES outcome;
increasing the YES price value for the YES outcome if the transaction comprises buying of the YES outcome; and
automatically decreasing the NO price value for the NO outcome if the transaction comprises buying of the YES outcome;
wherein sum of the increased YES price value and the decreased NO price value is equivalent to the number one constantly; and
wherein spot price of YES virtual coins is given by: n/(n+y)
and wherein if currency m is determined to be deposited for buying Δy coins, the system is configured to print ‘m’ number of YES coins and ‘m’ number of NO coins, wherein the m is computed to retain the unit price same as final spot price, wherein m is given by:
m=Δy*(n+m)/(n+y+2m−Δy)
where n is the number of NO virtual coins and y is the number of YES virtual coins with system and Δy is the YES virtual coins purchased by a trader for currency m;
and wherein after the purchase of Δy YES virtual coins, the system comprises (n+m) number of NO coins and (y+m−Δy) number of YES coins.

8. The computer implemented method of claim 7, wherein spot NO price value before purchase is y/(n+y), and wherein after purchase of Δy YES virtual coins, new spot YES price value is given by: YES price value=(n+m)/(n+y+2m−Δy) and new spot NO price value=(y+m−Δy)/(n+y+2m−Δy) where m is the amount of currency given for purchasing.

9. The computer implemented method of claim 1, wherein adjusting the computed YES price value for the YES outcome and the NO price value of the NO outcome based on the transaction comprises:
determining whether the transaction comprises buying of the NO outcome;
increasing the NO price value for the NO outcome if the transaction comprises buying of the NO outcome;
automatically decreasing the YES price value for the YES outcome if the transaction comprises buying of the NO outcome;
wherein the sum of the increased NO price value and the decreased YES price value is equivalent to the number one constantly; and
wherein if currency m is determined to be deposited for buying Δn coins, the system is configured to print m number of YES coins and m number of NO coins, wherein m is computed to retain the unit price as same value as final spot price, wherein m is given by:
m=Δn*(y+m)/(n+y+2m−Δn), where n is the number of NO virtual coins and y is the number of YES virtual coins with the system before the transaction, wherein after the purchase of Δn NO virtual coins, the system comprises (n+m−Δn) number of NO coins and (y+m) number of YES coins.

10. The computer implemented method of claim 11, wherein spot YES price value of YES virtual coins before purchase is n/(n+y) and spot NO price value of NO virtual coins before purchase is y/(n+y) and wherein after purchase of the Δn NO virtual coins, new spot YES price value is YES=(n+m−Δn)/(n+y+2m−Δn) and new spot NO price value is NO=(y+m)/(n+y+2m−Δn), where m is amount of money given for purchase.

11. The computer implemented method of claim 1, wherein adjusting the computed YES price value for the YES outcome and the NO price value of the NO outcome based on the transaction comprises:
determining whether the transaction comprises selling of YES virtual coins, wherein amount received by a trader, upon selling Δy YES virtual coins is Δy*(n−m)/(n+y−2m+Δy)), where n is the number of NO virtual coins, y is the number of YES virtual coins with system and m is amount of money received in lieu of selling Δy YES coins.

12. The computer implemented method of claim 11, wherein spot YES price value before selling is n/(n+y) and spot NO price value before selling is y/(n+y) and wherein after sale of the Δy YES virtual coins, new spot YES price value is YES=(n−m)/(n+y−2m+Δy) and new NO price value is NO=(y−m+Δy)/(n+y−2m+Δy).

13. The computer implemented method of claim 1, wherein adjusting the computed YES price value for the YES outcome and the NO price value of the NO outcome based on the transaction comprises:
determining whether the transaction comprises selling of NO virtual coins, wherein amount received by a trader, upon selling Δn NO virtual coins is Δn*(y−m)/(n+y−2m+Δn), where n is the number of NO virtual coins, y is the number of YES virtual coins with the system and m is money received in lieu of Δn NO coins.

14. The computer implemented method of claim 13, wherein spot YES price value before selling is n/(n+y) and spot NO price value before selling is y/(n+y) and wherein after sale of Δn NO virtual coins, new spot YES price value is YES=(n−m+Δn)/(n+y−2m+Δn) and new spot NO price value is NO=(y−m)/(n+y−2m+Δn).

15. A virtual automated market maker (VAMM) system for creating prediction markets, the VAMM system comprising:
one or more hardware processors; and
a memory coupled to the one or more hardware processors, wherein the memory comprises a plurality of modules in the form of programmable instructions executable by the one or more hardware processors, wherein the plurality of modules comprises:
a market setup module configured to:
receive a request for creating a prediction market for a binary event from event creator;
receive initial odds for the binary event from the event creator, wherein the initial odds comprises a YES outcome and a NO outcome, and wherein one of the YES outcome and the NO outcome correspond to higher probability of occurrence and the other of the YES outcome and the NO outcome correspond to least probability of occurrence;
receive a request for creating a desired virtual coins for the binary event and for the received initial odds from the event creator;
a virtual generator module configured to generate YES virtual coins corresponding to the YES outcome and NO virtual coins corresponding to the NO outcome based on the desired virtual coins and the received initial odds;
a price computing module configured to compute YES price value for the YES outcome and NO price value for the NO outcome based on the generated YES virtual coins, the NO virtual coins and the sum of the YES virtual coins and the NO virtual coins;
a market creator module configured to create the prediction market for the binary event based on the received odds, the desired virtual coins, the YES virtual coins, the NO virtual coins, the YES price value and the NO price value;
a transaction management module configured to determine whether there exists a transaction for the received binary event, wherein the transaction comprises buying and selling of the generated YES virtual coin and the NO virtual coins; and
a price optimization module configured to adjust the computed YES price value for the YES outcome and the NO price value of the NO outcome based on the transaction, wherein upon each transaction, the sum of the YES price value and the NO price value is adjusted to be equal to a number one constantly.

16. The VAMM system of claim 15, wherein the VAMM system further comprises a risk capital value computation module configured to:
compute a risk capital value for the received initial odds based on the following: risk capital value=Maximum of [number of NO virtual coins, number of YES virtual coins].

17. The VAMM system of claim 16, wherein the risk capital value computation module is further configured to:
output the computed risk capital value for the received initial odds on a user interface of a user device; and
obtain a payment of the computed risk capital value for the received initial odds from the event creator.

18. The VAMM system of claim 15, wherein number of virtual coins for each outcome depend on the received initial odds, wherein if probability of the binary event occurring is determined to be p, then the YES price value corresponds to p, and the NO price value corresponds to (1-p), and wherein the number of virtual coins generated is given by:
Number of YES virtual coins=N*(1-p); and
Number of NO virtual coins=N*p, where N is total number of coins desired.

19. The VAMM system of claim 15, wherein initial YES price value=NO virtual coins/(YES virtual coins+NO virtual coins) and initial NO price value=YES virtual coins/(YES virtual coins+NO virtual coins).

20. The VAMM system of claim 15, wherein in adjusting the computed YES price value for the YES outcome and the NO price value of the NO outcome based on the transaction, the price optimization module is further configured to:
determine whether the transaction is made for the YES outcome and whether no transaction is made for the NO outcome;
determine whether result of the binary event upon occurrence is equivalent to the YES outcome; and
adjust the computed YES price value for the YES outcome to be equivalent to the number one and the NO price value for the NO outcome to be equivalent to zero.

21. The VAMM system of claim 15, wherein in adjusting the computed YES price value for the YES outcome and the NO price value of the NO outcome based on the transaction, the price optimization module is further configured to:
determine whether the transaction comprises buying of the YES outcome;
increase the YES price value for the YES outcome if the transaction comprises buying of the YES outcome;
automatically decrease the NO price value for the NO outcome if the transaction comprises buying of the YES outcome;
wherein the sum of the increased YES price value and the decreased NO price value is equivalent to the defined number constantly; and
wherein spot price of YES virtual coins is given by: n/(n+y)
and wherein if currency m is determined to be deposited for buying Δy coins, the system is configured to print ‘m’ number of YES coins and ‘m’ number of NO coins, wherein the m is computed to retain the unit price same as final spot price, wherein m is given by:
m=Δy*(n+m)/(n+y+2m−Δy);
where n is the number of NO virtual coins and y is the number of YES virtual coins with system and Δy is the YES virtual coins purchased by a trader for currency m;
and wherein after the purchase of Δy YES virtual coins, the system comprises (n+m) number of NO coins and (y+m−Δy) number of YES coins.

22. The VAMM system of claim 21, wherein spot NO price value before purchase is y/(n+y), and wherein after purchase of Δy YES virtual coins, new spot YES price value is given by YES price value=(n+m)/(n+y+2m−Δy)and new spot NO price value=(y+m−Δy)/(n+y+2m−Δy) where m is the amount of currency given for purchasing.

23. The VAMM system of claim 15, wherein in adjusting the computed YES price value for the YES outcome and the NO price value of the NO outcome based on the transaction, the price optimization module is further configured to:
determine whether the transaction comprises buying of the NO outcome;
increase the NO price value for the NO outcome if the transaction comprises buying of the NO outcome;
automatically decrease the YES price value for the YES outcome if the transaction comprises buying of the NO outcome;
wherein the sum of the increased NO price value and the decreased YES price value is equivalent to the number one constantly; and
wherein if currency m is determined to be deposited for buying Δn coins, the system is configured to print m number of YES coins and m number of NO coins, wherein m is computed to retain the unit price as same value as final spot price, wherein m is given by:
m=Δn*(y+m)/(n+y+2m−Δn);
where n is the number of NO virtual coins and y is the number of YES virtual coins with the system before the transaction, wherein after the purchase of Δn NO virtual coins, the system comprises (n+m−Δn) number of NO coins and (y+m) number of YES coins.

24. The VAMM system of claim of claim 23, wherein spot YES price value of YES virtual coins before purchase is n/(n+y) and spot NO price value of NO virtual coins before purchase is y/(n+y) and wherein after purchase of the Δn NO virtual coins, the new spot YES price value is YES=(n+m−Δn)/(n+y+2m−Δn) and new spot NO price value is NO=(y+m)/(n+y+2m−Δn), where m is amount of money given for purchase.

25. The VAMM system of claim 15, wherein in adjusting the computed YES price value for the YES outcome and the NO price value of the NO outcome based on the transaction, the price optimization module is further configured to:
determine whether the transaction comprises selling of YES virtual coins, wherein amount received by a trader, upon selling Δy YES virtual coins is Δy*(n−m)/(n+y−2m+Δy)), where n is the number of NO virtual coins and y is the number of YES virtual coins with the system and m is amount of money received in lieu of selling Δy YES coins.

26. The VAMM system of claim 25, wherein spot YES price value before selling is n/(n+y) and spot NO price value before selling is y/(n+y) and wherein after sale of the Δy YES virtual coins, new spot YES price value is YES=(n−m)/(n+y−2m+Δy) and new NO price value is NO=(y−m+Δy)/(n+y−2m+Δy).

27. The VAMM system of claim 15, wherein in adjusting the computed YES price value for the YES outcome and the NO price value of the NO outcome based on the transaction, the price optimization module is further configured to:
determine whether the transaction comprises selling of NO virtual coins, wherein amount received by a trader, upon selling Δn NO virtual coins is Δn*(y−m)/(n+y−2m+Δn), where n is the number of NO virtual coins and y is the number of YES virtual coins with system and m is money received in lieu of Δn NO coins.

28. The VAMM system of claim 27, wherein spot YES price value before selling is n/(n+y) and spot NO price value before selling is y/(n+y) and wherein after sale of Δn NO virtual coins, new spot YES price value is YES=(n−m+Δn)/(n+y−2m+Δn) and new spot NO price value is NO=(y−m)/(n+y−2m+Δn).
